(19) United States
(12) Patent Application Publication
(10) Pub. No.: US 2008/0251442 A1
(43) Pub. Date: Oct. 16, 2008

(54) Fluid Treatment Assemblies and Elements and Methods for Making Them

(75) Inventors: Xianyao Shen, Ithaca, NY (US); Thomas J. Fendya, Homer, NY (US); Mark F. Hurwitz, Ithaca, NY (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 12/066,397

(22) PCT Filed: Sep. 26, 2006
(86) PCT No.: PCT/US06/37546

§ 371 Date: Mar. 11, 2008

Related U.S. Application Data
(60) Provisional application No. 60/721,077, filed on Sep. 28, 2005.

(51) Int. Cl. B01D 27/06; B29C 53/40; B01D 63/14; B01D 63/02

(52) U.S. Cl. 210/315; 210/493.2; 210/321.86; 156/218

(57) ABSTRACT

Fluid treatment assemblies and elements may include a plurality of axially extending pleats and may be used to treat fluids, including gases, liquids, or mixtures of gases, and/or solids, in a crossflow mode of operation. For example, some fluid treatment assemblies and elements may be used to remove one or more substances from the fluid and may then function as separators, including filters and concentrators. Other fluid treatment assemblies and elements may be used to transfer substances between two fluid streams and may then function as mass transfer devices.

### DISCLOSURE OF THE INVENTION

The present invention relates to fluid treatment assemblies and elements which may be used to treat fluids, including gases, liquids, or mixtures of gases, liquids and/or solids, in a wide variety of ways. For example, some of the fluid treatment assemblies and elements may be used to remove one or more substances from the fluid and may then function as concentrators or filters or other types of separators. Others of the fluid treatment assemblies and elements may be used to transfer substances between two fluid streams and may then function as mass transfer devices.

In particular, the present invention relates to pleated fluid treatment assemblies and elements which are structured to treat a fluid in a crossflow mode of operation. The pleated fluid treatment elements include a fluid treatment medium, e.g., either as a single sheet or as one or more layers of a multilayer composite. The single sheet or the multilayer composite may be folded or corrugated in a zigzag fashion to create several pleats. Each pleat has a folded end, an open end, and two legs that extend between the folded end and the open end. Opposite end edges of the pleated sheet or composite are sealed to one another along an edge seal to form a generally cylindrical fluid treatment pack with each pleat extending generally axially along the fluid treatment pack.

The fluid treatment assemblies and elements may include a first fluid flow path that passes tangentially along the pleats of the fluid treatment pack and a second fluid flow path that passes through the pleated fluid treatment medium from or to the first fluid flow path. Feed fluid may enter the fluid treatment assembly or element along the first fluid flow path. The feed fluid then passes via the first fluid flow path axially along the fluid treatment pack and tangentially within the pleats of the pack, where the feed fluid is treated. For example, one or more substances, including one or more constituents of the feed fluid, may be removed from the feed fluid by passing out of the feed fluid along the second fluid flow path through the fluid treatment medium. Alternatively, one or more substances may be added to the feed fluid by passing into the feed fluid along the second fluid flow path through the fluid treatment medium. The treated feed fluid then continues along the first fluid flow path out of the fluid treatment assembly or element.

In accordance with one aspect of the invention, fluid treatment elements may comprise a fluid treatment pack, a sealant, and first and second fluid flow paths. The fluid treatment pack includes a fluid treatment medium which has first and second surfaces. The fluid treatment pack also includes an axis, first and second opposite ends, and a plurality of pleats which extend axially between the first and second ends of the pack. Each pleat includes first and second axial ends at the first and second ends of the fluid treatment pack, respectively. Each pleat further includes a folded end, an open end, first and second legs which extend between the folded end and the open end of the pleat, and a region free of structure. The region free of structure extends axially within the pleat between the first and second axial ends along the first surface of the fluid treatment medium and opens onto the first and second axial ends of the pleat. The sealant seals each end of the fluid treatment pack from the second surface of the fluid treatment medium. The first fluid flow path extends axially along the pleated fluid treatment pack within the pleats and includes the regions free of structure. The second fluid flow path extends through the fluid treatment medium from or to the first fluid flow path.

In accordance with another aspect of the invention, fluid treatment elements may comprise a hollow, generally cylindrical fluid treatment pack, a sealant, and a core. The fluid treatment pack includes an axis, an interior, first and second opposite ends, and a pleated composite. The pleated composite includes a fluid treatment medium having an inner surface and an outer surface and defines a plurality of pleats extending axially between the first and second ends of the fluid treatment pack. Each pleat includes first and second axial ends at the first and second ends of the fluid treatment pack, respectively. Each pleat further includes a folded outer end, an open inner end, first and second legs which extend between the folded outer end and the open inner end, and a region free of structure. The region free of structure extends axially within the pleat between the first and second axial ends along the inner surface of the fluid treatment medium and opens onto the first and second axial ends of the pleat. The sealant seals each end of the fluid treatment pack from the outer surface of the fluid treatment medium. The core is positioned in the hollow interior of the fluid treatment pack along the open inner ends of the pleats.

In accordance with another aspect of the invention, fluid treatment elements may comprise a generally cylindrical fluid treatment pack, a sealant, and an outer surround. The fluid treatment pack includes an axis, an exterior, first and second opposite ends, and a pleated composite. The pleated composite includes a fluid treatment medium having an inner surface and an outer surface and defines a plurality of pleats extending axially between the first and second ends of the fluid treatment pack. Each pleat includes first and second axial ends at the first and second ends of the fluid treatment pack, respectively. Each pleat further includes a folded inner end, an open outer end, first and second legs which extend between the folded inner end and the open outer end, and a region free of structure. The region free of structure extends axially within the pleat between the first and second axial ends along the outer surface of the fluid treatment medium and opens onto the first and second axial ends of the pleat. The sealant seals each end of the fluid treatment pack from the inner surface of the fluid treatment medium. The outer surround is positioned around the exterior of the fluid treatment pack along the open outer ends of the pleats.

In accordance with another aspect of the invention, methods of making a fluid treatment element may comprise corrugating a fluid treatment medium having first and second opposite surfaces to form a plurality of pleats and forming the corrugated fluid treatment medium into a generally cylindrical fluid treatment pack. The fluid treatment pack has first and second opposite ends and the pleats extend axially along the fluid treatment pack between the first and second ends. The methods also comprise positioning a stripout material along the first surface of the fluid treatment medium and applying a sealant to the fluid treatment pack near the first and second ends to seal the ends of the fluid treatment pack from the second surface of the fluid treatment medium. The methods further comprise removing the stripout material from the corrugated fluid treatment pack to form a region within each pleat that is free of structure. The stripout material is removed from the fluid treatment pack after the sealant is applied to the ends of the fluid treatment pack.

In accordance with another aspect of the invention, methods of making a fluid treatment element may comprise forming a composite which includes a fluid treatment medium having first and second opposite surfaces and a stripout material positioned along the first surface of the fluid treatment medium. The methods also comprise corrugating the composite to form a plurality of pleats and forming the corrugated composite into a generally cylindrical fluid treatment pack having first and second ends, where the pleats extend axially along the fluid treatment pack. The methods further comprise applying a sealant to the fluid treatment pack near the first and second ends to seal the ends of the fluid treatment pack from the second surface of the fluid treatment medium. The methods further comprise removing the stripout material from the corrugated composite to form a region within each pleat that is free of structure. The stripout material is removed from the composite after the sealant is applied to the ends of the fluid treatment pack.

Embodiments of the invention have many advantages. For example, by providing regions within the pleats that are free of structure, feed fluid can flow along these regions with less resistance to fluid flow. Consequently, feed fluid may flow tangentially through the fluid treatment pack with less pressure drop. Further, by locating the regions free of structure directly next to a surface of the fluid treatment medium, fluid flowing along the tangential flow path through these regions may have higher and more uniform shear rates and maintain the surface of the fluid treatment medium more thoroughly free of foulants. In addition, many feed fluids deposit foulants when they flow through or around obstructions in the flow path in the fluid flow path. By providing regions within the pleats that are free of structure, embodiments of the invention allow feed fluid to flow along the tangential flow path through the fluid treatment pack without depositing significant amounts of foulants on the fluid treatment medium. Consequently, the performance of the fluid treatment element can be enhanced and the service life of the fluid treatment elements can be extended.

### BRIEF DESCRIPTION OF THE DRAWINGS

FIG. 1 is a sectioned view of a fluid treatment assembly.

FIG. 2 is an end view of the fluid treatment assembly shown in FIG. 1.

FIG. 3 is a sectioned view showing the foreground of the fluid treatment assembly, as shown in FIG. 1.

FIG. 4 is a representational view of a multilayer composite including a fluid treatment medium.

FIG. 5 is an oblique view of a cylindrical fluid treatment pack.

FIG. 6 is a sectioned side view of a portion of a fluid treatment pack in a fixture.

FIG. 7 is an oblique view of a stripout material in a fluid treatment pack.

FIG. 8 is a sectioned view of another fluid treatment assembly.

FIG. 9 is a sectioned view of the fluid treatment element shown in FIG. 8.

FIG. 10 is a sectioned view showing the foreground of the fluid treatment assembly shown in FIG. 8.

FIG. 11 is a sectioned view of a portion of a fluid treatment pack in a fixture.

### DESCRIPTION OF EMBODIMENTS

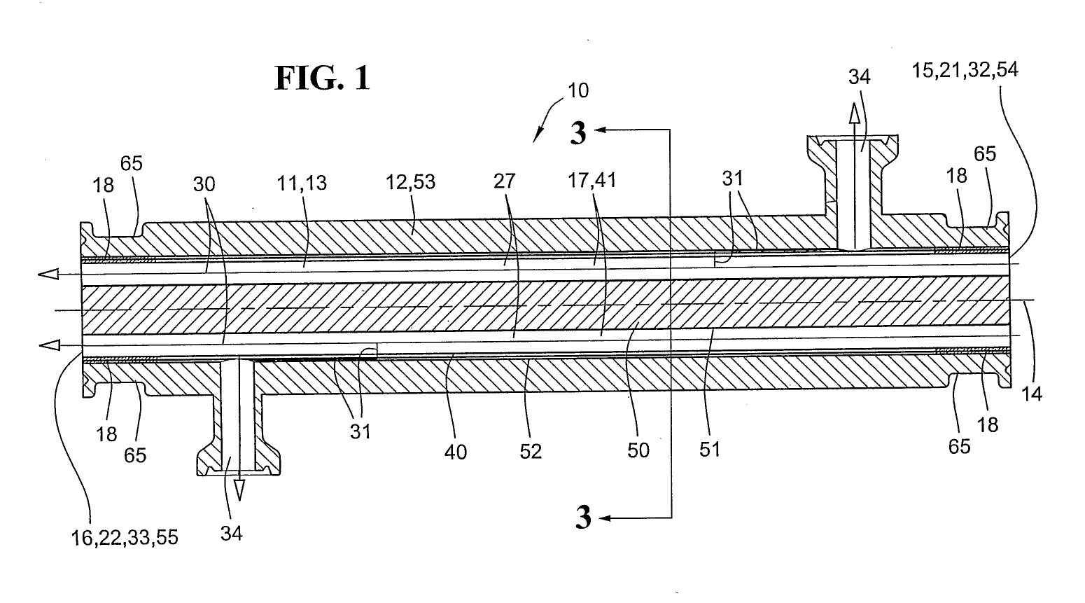

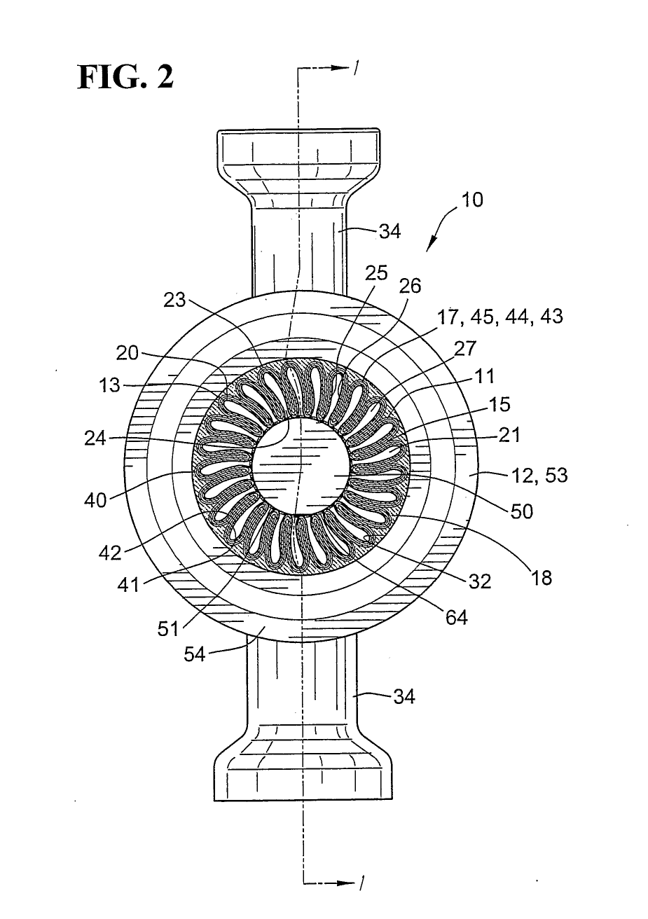

Many different fluid treatment elements and assemblies may embody the invention. An example of a fluid treatment assembly 10 is shown in FIGS. 1-3 and comprises a fluid treatment element 11 contained in a housing 12. The fluid treatment element 11 generally includes a hollow, generally cylindrical fluid treatment pack 13 having a central axis 14, opposite ends 15, 16, a fluid treatment medium 17, and a plurality of pleats 20. The pleats 20 extend generally axially between the ends 15, 16 of the pack 13. The pleats 20 may extend inwardly or outwardly in a radial direction or in a curved, arcuate, angled or straight nonradial direction. Each pleat 20 may include opposite axial ends 21, 22 at the respective opposite ends 15, 16 of the fluid treatment pack 13. Each pleat 20 may further include a folded end, e.g., a folded outer end 23, an open end, e.g., an open inner end 24, and two legs 25, 26 which extend between the folded end 23 and the open end 24. All or substantially all, i.e., at least about 85% or at least about 90% or at least about 95% or 100%, of the pleats 20 of the fluid treatment pack 13 include a region 27 free of structure. Greater percentages are preferred because they provide more regions free of structure within the fluid treatment pack. The region 27 free of structure extends axially within each pleat 20 along the full length of the pleat 20 between the axial ends 21, 22 and opens onto the axial ends 21, 22 of the pleat 20. The fluid treatment medium 17 has an inner surface and an outer surface, and the region 27 free of structure extends axially within the pleat 20 along one of the surfaces, e.g., the inner surface, of the fluid treatment medium 17. A sealant 18 at each end of the fluid treatment pack 13 seals the other of the surfaces, e.g., the outer surface, of the fluid treatment medium 17 from the ends 15, 16 of the fluid treatment pack 13. The fluid treatment element 11 further includes a tangential fluid flow path 30 and a lateral fluid flow path 31. The tangential fluid flow path 30 extends generally axially along the fluid treatment pack 13 within the pleats 20, including the regions 27 free of structure. The lateral fluid flow path 31 fluidly communicates with the tangential fluid flow path 30 and extends laterally through the fluid treatment medium 17 to or from the tangential fluid flow path 30.

In operation, feed fluid may pass tangentially along the fluid treatment pack 13 via the tangential fluid flow path 30. For example, feed fluid may pass along the tangential fluid flow path 30 though a feed or process fluid inlet 32 of the housing 12 into the regions 27 free of structure at the open axial ends 21 of the pleats 20. The feed fluid then passes via the regions 27 free of structure along one surface of the fluid treatment medium 17, exiting the fluid treatment pack 13 and the housing 12 at the opposite open axial ends 22 of the pleats 20 and a retentate or concentrate outlet 33. Within the regions 27 free of structure the feed fluid may be treated, for example, by removing one or more substances from the feed fluid via the lateral fluid flow path 31 through the fluid treatment medium 17 or by adding one or more substances to the feed fluid via the lateral fluid flow path 31 through the fluid treatment medium 17. For example, one or more components of the feed fluid may be removed by passing through the fluid treatment medium 17 and through one or more permeate or filtrate outlets 34 of the housing 12. The fluid treatment element 11 may thus be considered a pleated, crossflow fluid treatment element. International Publication No. WO 00/13767 and International Publication No. WO 2005/094963 also disclose pleated, crossflow fluid treatment elements and are incorporated by reference in their entirety for any and all purposes.

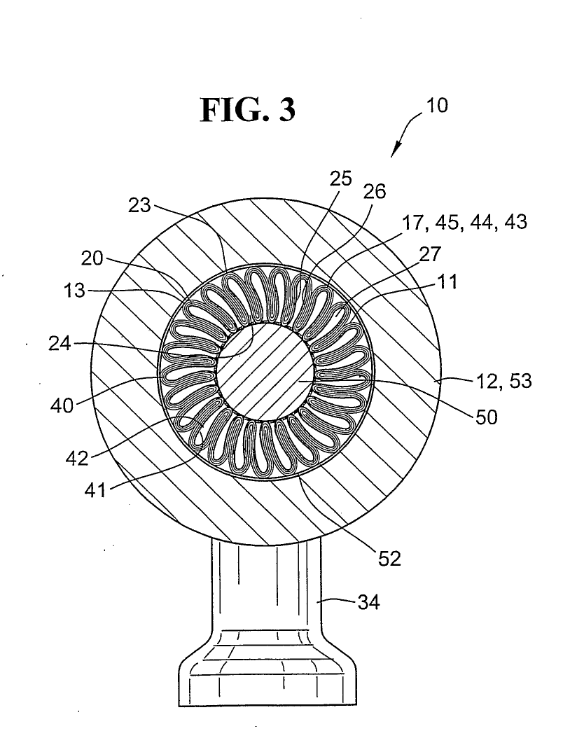

The fluid treatment pack 13 may be structured in a wide variety of ways. For example, the fluid treatment pack may include a pleated, multilayer composite 40, as shown in FIG. 3. Some or all of the layers of the composite 40 may be integrally joined to or formed with one another. For example, they may be heat bonded, solvent bonded, or adhesively bonded to one another along all or a portion of the adjacent surfaces of the layers. However, in many embodiments, the layers of the composite 40 may comprise separate layers positioned adjacent to one another but not affixed to one another except in the vicinity of the sealant, where the sealant may affix the layers to one another.

The fluid treatment pack 13 includes a fluid treatment medium 17 as one or more of the layers of the composite 40. The fluid treatment medium 17 may have opposite surfaces, e.g., an inner surface 41 and an outer surface 42. Suitable fluid treatment media may vary widely depending on such factors as the nature of the feed fluid and how the feed fluid is to be treated. For example, the fluid treatment medium may have, or may be modified to have, any of a myriad of properties. The fluid treatment medium may be porous, including permeable, semipermeable, or permselective, and may have removal efficiencies, including molecular weight cutoffs, from the Angstrom or Dalton range or less, through the submicron range, to the micron or tens of microns range or more. For example, the fluid treatment medium may comprise a reverse osmosis, a nanofiltration, an ultrafiltration, or a microfiltration medium. The fluid treatment may allow gas and liquid to pass through it or just gas and not liquid. The fluid treatment medium may be liquiphobic or liquiphilic, may have an electrically neutral or charged surface, and/or may include one or more functional groups which may, for example, be arranged to bind to one or more substances in the feed fluid. The fluid treatment medium may be configured in a variety of ways, including, for example, as a permeable, semipermeable, or permselective membrane or a porous sheet, such as a fibrous sheet, and may be formed from any suitable material, including metal, natural or synthetic polymers, or a ceramic or glass. For many embodiments, a permeable polymeric membrane having a submicron removal rating or finer may be used as the fluid treatment medium.

The fluid treatment pack 13 may include one or more layers in addition to the fluid treatment medium 17. For example, the fluid treatment pack 13 may include a porous drainage medium as another layer of the multilayer composite 40. The drainage medium may comprise a downstream or permeate drainage layer 43 which is positioned along a surface, e.g., the outer surface 42, of the fluid treatment medium 17 either adjoining the outer surface 42 or spaced from the outer surface 42 of the fluid treatment medium 17. The drainage layer 43 may comprise any of a variety of materials having a sufficiently low edgewise flow resistance to enable fluid to adequately flow to or from the outer surface 42 of the pleated fluid treatment medium 17 parallel to the pleat legs. Many suitable drainage media are disclosed, for example, in U.S. Pat. No. 5,543,047 and U.S. Pat. No. 5,252,207, both of which are incorporated by reference in their entirety for any and all purposes. For many embodiments, a woven or nonwoven polymeric fibrous material or a polymeric mesh may be used as the drainage medium. For example, the permeate drainage layer 43 may comprise an extruded polymeric mesh having first and second biplanar sets of strands. For the extruded mesh layer, as well as any other mesh layer, either set of strands, or neither set of strands, may be oriented within the composite 40 parallel to the axis 14 of the fluid treatment pack 13.

The multilayer composite 40 may also include other layers. For example, the permeate drainage layer 43 may be positioned along the outer surface 42 of the fluid treatment medium 17 with a downstream or permeate porous support layer 44 and a downstream or permeate porous cushioning layer 45 between them. The permeate support layer 45 extends along the outer surface 42 of the fluid treatment medium 17 and an inner surface of the permeate drainage layer 43 and supports the fluid treatment medium 17, as well as the permeate cushioning layer 45. For example, the permeate support layer 44 may support the fluid treatment medium 17 against forces, such as the forces associated with the transmembrane pressure, which press the fluid treatment medium 17 into the permeate drainage layer 43, thereby resisting extrusion of the fluid treatment medium 17, as well as the permeate cushioning layer 45, into the channels and openings of the permeate drainage layer 43. The permeate support layer 44 may comprise a wide variety of woven or nonwoven polymeric fibrous materials or polymeric meshes which may be finer than the mesh of the permeate drainage layer 43.

The downstream cushioning layer 45 may be immediately adjacent to the fluid treatment medium 17 and extend along the outer surface of the fluid treatment medium 17 and inner surfaces of the permeate support layer 44 and the permeate drainage layer 43. The permeate cushioning layer 45 protects the fluid treatment medium 17 from damage from the other downstream layers 43, 44. For example, the permeate cushioning layer 45 protects the fluid treatment medium 17 from abrasion by the downstream support layer 44 or the downstream drainage layer 43. For many embodiments the cushioning layer may comprise a nonwoven fibrous material which is thin, smooth, and tough.

The regions 27 free of structure within the pleats 20 generally provide spaces or channels within the pleats 20 through which fluid, e.g., feed fluid, may flow from one end 15, 16 of the fluid treatment pack 13 to the other end 16, 15. Each region 27 extends axially along a pleat 20 between the legs 25, 26 of the pleat 20. The widths of the regions 27 free of structure, i.e., the distance from one pleat leg to the other, may vary or may be constant from region 27 to region 27. Further, the width of a region 27 free of structure may vary or may be constant along the axial length of the region 27 and/or along the height of the pleat 20. For many embodiments, the nominal width of the region 27 free of structure may be in the range from about 10 thousandths of an inch or less to about 200 thousandths of an inch or more, e.g., from about 20 to about 150 thousandths of an inch or from about 40 to about 130 thousandths of an inch. In addition, the height of each region 27 free of structure may be at least about 50% or at least about 75% or at least about 90% or about 100% of the height of the pleat 20 between the folded end 23 and the open end 24 of the pleat 20. Again, greater percentages are preferred because they provide larger regions 27 free of structure.

Each region 27 free of structure may extend between the axial ends 21, 22 of the pleat 20 without obstruction. For example, the regions 27 free of structure may not include a spacer arrangement, such as one or more spacers inserted within the filter pack and/or between the legs of the pleat, to define or maintain a region free of structure within the pleat 20. Further, for most embodiments each region 27 free of structure may be positioned immediately adjacent to the fluid treatment medium 17, adjoining a surface, e.g., the inner surface 41, of the fluid treatment medium 17. Consequently, fluid such as feed fluid flowing along the tangential flow path 30 passes through the regions 27 free of structure with less pressure drop and at a higher, more uniform shear rate along the surface of the fluid treatment element 17.

In addition to the fluid treatment pack 13 and the regions 27 free of structure, the fluid treatment element 11 may include other features. For example, the fluid treatment element 11 may include a core 50 positioned in the interior of the fluid treatment pack 13, for example, along the open inner ends 24 of the pleats 20. The core 50, which may serve to inhibit fluid flow from the open inner ends 24 of the pleats 20, may be variously configured. For example, the core 50 may comprise a solid rod, or a hollow tube capped at each end. The core may have a outer surface 51 which closes off the open inner ends 24 of the pleats 20. The core 50 then directs fluid into or out of the open axial ends 21, 22 of the pleats 20 and inhibits fluid flow radially inwardly through the open inner ends 24 of the pleats 20, confining the fluid along the tangential flow path 30 within the regions 27 free of structure.

The fluid treatment element 11 may also include a surround 52, such as a cage, a sleeve, or a wrap, positioned around the exterior of the fluid treatment pack 13. The surround may be perforated or porous, or may have other openings, along all or only a portion of the axial length of the surround. For some embodiments, the surround may be impermeable. In the illustrated embodiment, the surround 52 has openings along the entire axial length and may comprise one or more layers of a polymeric mesh, e.g., an extruded polymeric mesh, circumferentially wrapped around the exterior of the fluid treatment pack 13. The surround may abut the pleats 20, e.g., the folded outer ends 23 of the pleats 20, and assist in holding the pleats 20 in position and maintaining fluid communication between the fluid treatment medium and the permeate outlet.

The housing 12 may be configured in many different ways to contain the fluid treatment element 11. For example, the housing 12 may include a shell 53 which surrounds the exterior of the fluid treatment element 11 and has opposing open ends 54, 55. The housing 12 may also include a plurality of ports which may be variously configured. For example, the housing 12 may have a feed or process fluid inlet port 32, and the feed inlet port 32 may simply comprise one of the open ends 54, 55 of the shell 53. The housing 12 may also have a retentate or concentrate outlet port 33, and the retentate outlet port 33 may simply comprise the other of the open ends 55, 54 of the shell 53. At least one permeate or filtrate outlet port 34, e.g., two permeate outlets 34 located near the ends of the shell 53 and angularly displaced by 180°, may also be associated with the housing 12.

A sealant 18, which may extend radially outwardly from the fluid treatment medium 17 to the shell 53 of the housing 12 at each end of the fluid treatment element 11, seals each end 15, 16 of the fluid treatment pack 13 from one surface, e.g., the outer surface 42 or permeate side, of the fluid treatment medium 17. The sealant 18 may also serve to affix the fluid treatment element 11 to the housing 12 and/or to affix the fluid treatment medium 17 in position, e.g., to affix the fluid treatment medium 17 to one or more other layers of the fluid treatment pack 13. Various sealants, including, for example, epoxies, urethanes, or polyolefins, may be utilized. For many embodiments the sealant may be an epoxy. The sealant 18 may extend axially inwardly from each end of the fluid treatment element 11 a distance in the range from about ⅛ inch or less to about one inch or more. The sealant 18, in conjunction with the housing 12, directs fluid along the lateral flow path 31 from or to the tangential flow path 30 through the fluid treatment medium 17. For example, permeate or filtrate may be directed along the lateral flow path 31 from the tangential flow path 30 and the regions 27 free of structure through the fluid treatment medium 17 to the surround 52 and along the surround 52 to a permeate outlet port 34 of the housing 12.

A sealant 64 may also be positioned between the core 50 and the pleats 20 at each end of the fluid treatment pack 13, e.g., on the feed side of the fluid treatment medium 17. The sealant 64 may affix the legs 25, 26 of adjacent pleats 20 to the core 52 without significantly obstructing the regions 27 free of structure. The sealant 64 may extend axially along the entire length of the core 52. For some embodiments, the sealant 64 may extend axially from an end into interior of the fluid treatment pack a distance in the range from about ⅛ inch or less to about one inch or more. With the core 52 and the shell 53 of the housing 12 affixed to the fluid treatment element 11, the housing 12 may not include, e.g., may be free of, any end pieces which extend between the core 50 and the shell 53, as shown in FIG. 1. No portion of the housing 12 then has an inner diameter less than the outer diameter of the fluid treatment pack. This simplifies manufacture and reduces the amount of waste to be discarded when the fluid treatment assembly 10 is spent. The ends of the shell 53 may each be configured as a fitting, e.g., a portion of a tri-clamp fitting 65, and connected to corresponding fittings on an inlet line and an outlet line (not shown).

The fluid treatment element or assembly may be made in any of numerous ways. For example, one method may generally comprise corrugating at least a fluid treatment medium having first and second surfaces to form a plurality of pleats and forming the corrugated fluid treatment medium into a generally cylindrical fluid treatment pack. The fluid treatment pack has first and second ends and the pleats extend axially along the fluid treatment pack between the first and second ends of the pack. The method also comprises positioning a stripout material along the first surface of the fluid treatment medium and applying a sealant to the fluid treatment pack near the first and second ends to seal the ends from the second surface of the fluid treatment medium. The method further comprises removing the stripout material from the corrugated fluid treatment pack to form a region within each pleat that is free of structure.

Another method may generally comprise corrugating a multilayer composite to form a plurality of pleats and forming the corrugated composite into a generally cylindrical fluid treatment pack. The multilayer composite includes at least a fluid treatment medium having first and second opposite surfaces and a stripout material positioned along the first surface of the fluid treatment medium. The cylindrical fluid treatment pack has first and second ends and the pleats extend axially along the fluid treatment pack. The method further comprises applying a sealant to the fluid treatment pack near the first and second ends to seal the ends from the second surface of the fluid treatment medium and, after applying the sealant, stripping the stripout material from the corrugated composite to form a region free of structure within each pleat.

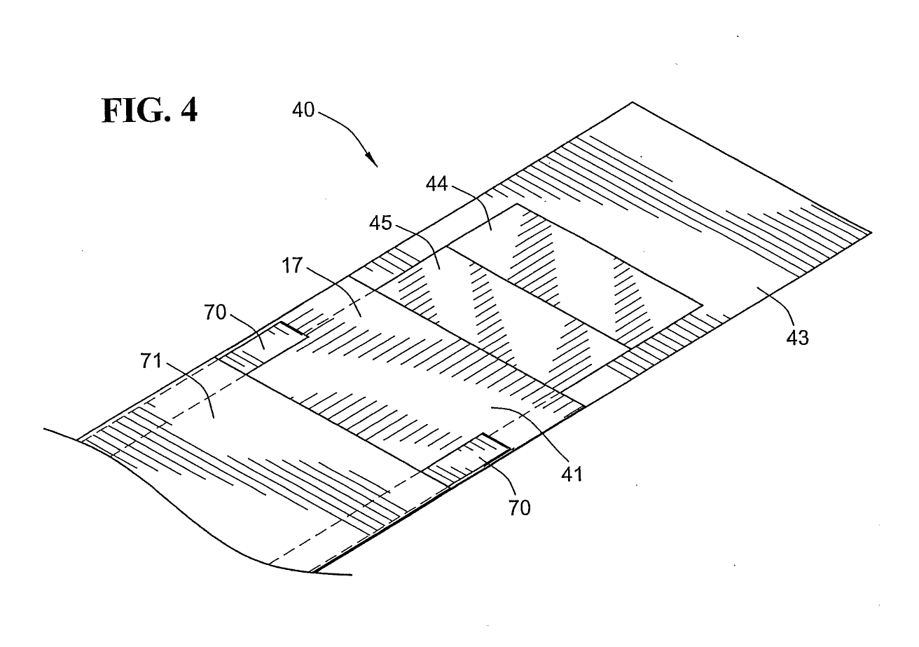

A more specific example of a method of making a fluid treatment assembly may initially involve forming the multilayer composite 40, as shown in FIG. 4. Forming the composite 40 may include arranging the permeate drainage layer 43, the permeate support layer 44 and the permeate cushioning layer 45 along the surface of the fluid treatment medium 17 that will become the outer surface 42. The permeate drainage layer 43 may be the same width as the fluid treatment medium 17 and their side edges may be aligned. The permeate support layer 44 and the permeate cushioning layer 45 may be somewhat narrower than the fluid treatment medium 17. For example, the side edges of the permeate support layer 44 and the permeate cushioning layer 45 may be parallel to but spaced inwardly from the side edges of the fluid treatment medium 17, for example, by up to about ¾ inch.

The multilayer composite 40 may also be formed with one or more layers along the surface of the fluid treatment medium 17 that will become the inner surface 41. For example, a sealant barrier layer 70 and a stripout material 71 may be arranged along the inner surface 41 of the fluid treatment medium 17. The sealant barrier layer may comprise a single sheet having a width similar to the width of the fluid treatment medium. However, for most embodiments the sealant barrier layer 70 may comprise two narrow strips positioned along the side edges of the fluid treatment medium 17 and, in many instances, spaced inwardly from the side edges of the fluid treatment medium. For example, the strips of the sealant barrier layer 70 may be up to about 1 inch wide or more, and a side edge of each strip may be arranged parallel to but spaced inwardly by up to about ¼ inch or more from the side edge of the fluid treatment medium 17. The sealant barrier layer 70 may be formed from a variety of materials that will provide a barrier to the sealant. For many embodiments, the sealant barrier layer 70 may be formed from a thin, impermeable polymeric film that resists bonding to the sealant.

The stripout material 71 may be arranged along the inner surface 41 of the fluid treatment medium 17. The stripout material 71 may have the same width as the fluid treatment medium 17, and their side edges may be aligned. Removal of the stripout material 71 from the fluid treatment pack 13 establishes the regions 27 free of structure, and the thickness of the stripout material generally corresponds to, e.g., may be about one half of, the width of each region 27 free of structure. Consequently, the thickness of the stripout material 71 may be selected in accordance with the desired number of pleats 20 and the desired size of the regions 27 free of structure. The stripout material 71 may be structured in a wide variety of ways and may be fashioned from any of numerous materials. For example, the stripout material may comprise a single layer or multiple layers that are flexible enough to be corrugated with the fluid treatment medium 17. Further, the stripout material may be fashioned from a sheet material which resists compression and which prevents damage to the fluid treatment medium during corrugation. For many embodiments, the stripout material 71 may comprise a multilayer composite, e.g., a three-layer composite including a cushioning layer, a support layer and a drainage layer similar to the permeate cushioning layer 45, the permeate support layer 44, and the permeate drainage layer 43 previously described.

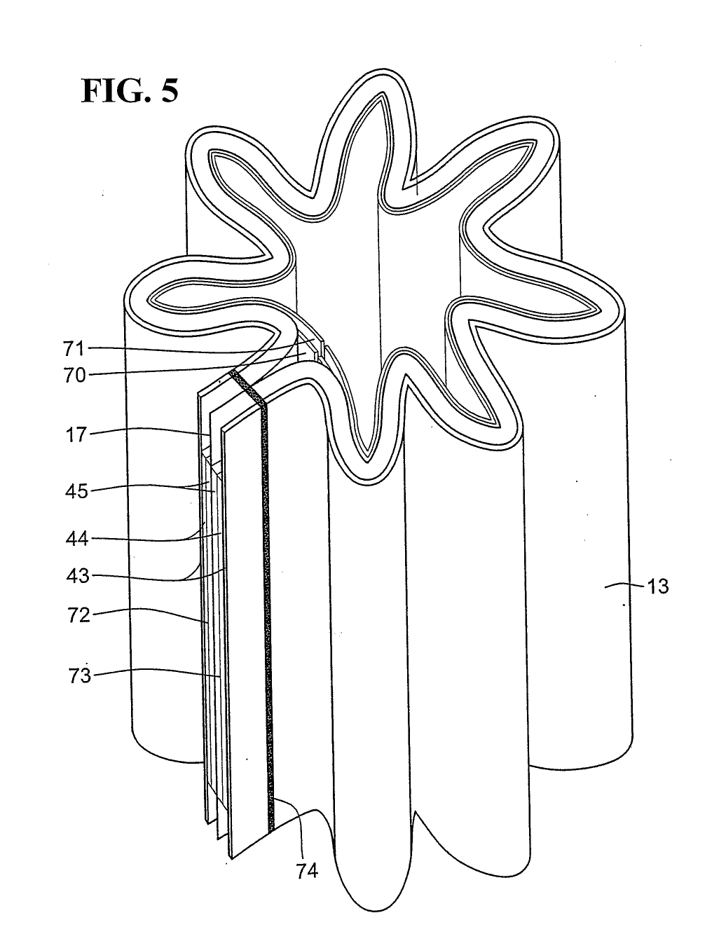

The multilayer composite 40 may then be corrugated to form a plurality of pleats 20. The composite may be corrugated by any of numerous corrugators and the pleats may be variously configured. For example, the legs of each pleat may have about equal lengths or one leg may be longer than the other. After the multilayer composite 40 has been corrugated, a cutter may cut the pleated composite in a direction parallel to the pleats 20, providing a leading edge 72, a trailing edge 73, and a predetermined number of pleats 20. The pleated composite is then formed into a generally cylindrical pack 13. For example, the leading edge 72 and the trailing edge 73 of the pleated composite 40 may be brought around and positioned next to one another, as shown in FIG. 5, forming a hollow, generally cylindrical fluid treatment pack 13 having an interior, an exterior, and opposite ends 15, 16. A side seal 74 may be formed along the leading and trailing edges 72, 73 in any number of ways including, for example, melt bonding, adhesive bonding, and/or mechanically connecting. For most embodiments, the sealant barrier layer 70 and the stripout material 71 may be trimmed back from the leading and trailing edges 72, 73 so they do not form part of the side seal 74.

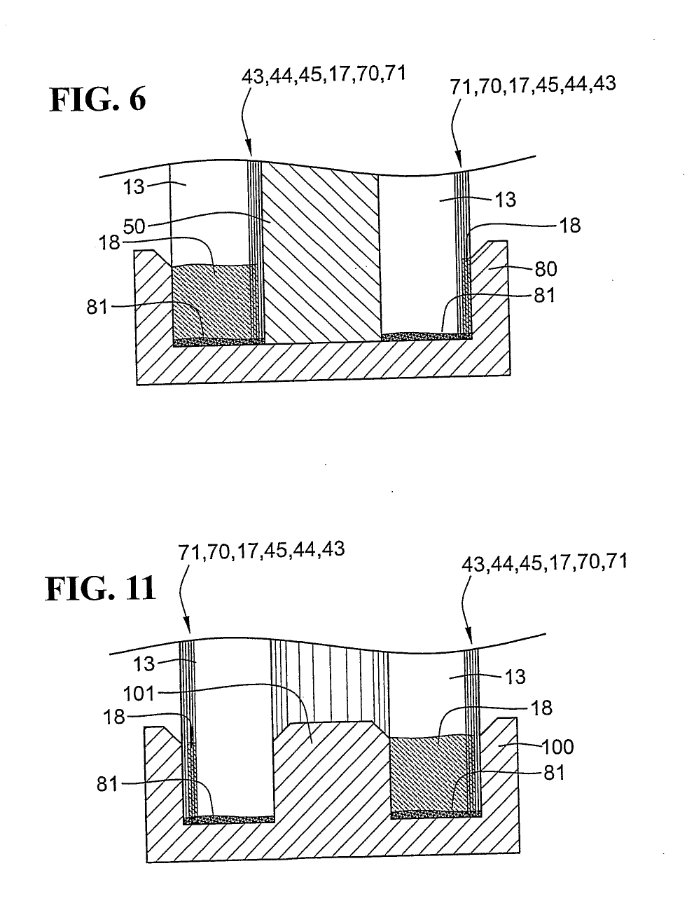

After the fluid treatment pack 13 is formed, one or more sealants may be applied. The amount and viscosity of any of the sealants and the wetability of the various layers which contact the sealant may be selected to prevent insufficient or excessive wicking of the sealant axially along the layers. The sealant may be applied in any of several ways. For example, each end 15, 16 of the pack 13 may be dipped into a sealant 81 such that the sealant 81 fills the end 15, 16 of the pack 13 to an axial depth of up to about ⅛ inch or more from each end 15, 16 of the pack 13. As shown in FIG. 6, each end 15, 16 of the fluid treatment pack 13 may be dipped in a cup-shaped fixture 80 containing the sealant 81 at the bottom. The fixture 80 may have an inner diameter which corresponds to the desired outer diameter of the fluid treatment pack 13 and a depth of about 1 inch or less to about 1¼ inch or more, with a slight taper near the top. A core 50 or a core substitute may be inserted in the interior of the fluid treatment pack 13 before the pack 13 is dipped in the sealant 81 in the fixture 80.

After the initially-applied sealant 81 solidifies, a sealant 18 may then be applied between the fluid treatment pack 13 and the inner-diameter of cup-shaped fixture 80, filling all void spaces in the fluid treatment pack 13 radially between the outer surface 42 of the fluid treatment medium 17 and the inner diameter of the fixture 80 and axially between the initially-applied sealant 81 and, for example, the bottom of the taper near the top of the fixture 80, as shown in FIG. 6. The sealant 18 penetrates into the voids of the permeate drainage layer 43 in an end region of the fluid treatment pack 13 extending from near the bottom to near the top of the fixture 80. Because the side edges the permeate cushioning and support layers 44, 45 are spaced inwardly from the side edge of the fluid treatment medium 17, as shown in FIG. 4, the sealant 18 may penetrate into the voids of the permeate cushioning and support layers 44, 45 only about 1/16 inch to about ½ inch axially inwardly from the edges of the permeate cushioning and support layers 44, 45. The sealant 18 may also penetrate into the voids of the fluid treatment medium 17 in an end region extending from near the bottom to near the top of the fixture 80, passing through the fluid treatment medium 17 to the inner surface 41 of the fluid treatment medium 17 where it is blocked by the sealant barrier strip 70. Alternatively, the sealant 18 may simply bond to the outer surface 42 of the fluid treatment medium 17 without passing through to the inner surface 41.

After the sealant 18 solidifies, the outer surface 42 of the fluid treatment medium 17 is sealed from the ends 15, 16 of the fluid treatment pack 13. The permeate drainage layer 43 and the fluid treatment medium 17, as well as the permeate support layer 44 and the permeate cushioning layer 45, are effectively bonded to one another in the end regions of the fluid treatment pack 13 by the sealant 18. Further, the legs 25, 26 of adjacent pleats 20 are embedded in the sealant 18 and are effectively bonded to one another outwardly from the fluid treatment medium 17 in the end regions of the fluid treatment pack 13. However, the stripout material 71 and the sealant barrier strips 70, may be bonded to the fluid treatment pack 13 only by the initially-applied sealant 81.

Although the surround 52 may be installed around the fluid treatment pack 13 before any sealant 81, 18 is applied, for many embodiments, the surround 52 may be installed after the sealant 81, 18 is applied. The surround 52 may be in the form of a sheet or strip and may be circumferentially or helically wound around the fluid treatment pack 13 in one or more layers. Alternatively, the surround may be in the form of a cylindrical cage or sleeve and may be axially slid onto the fluid treatment pack. For many embodiments, the outer diameter of the surround 52 may closely correspond to the inner diameter of the housing 12.

The fluid treatment element 11, including the fluid treatment pack 13, the sealant 81, 18, the core 50, and the surround 52, may be installed in the housing 12. For example, the fluid treatment element 11 may be axially slid into the shell 53 of the housing 12, with the surround 52 abutting the housing 12 and fluidly communicating between the outer surface 42 of the fluid treatment medium 17 and one or more permeate outlets 34. A sealant may be applied to the fluid treatment element 11 before it is slid into the shell 53 to assist in bonding the fluid treatment pack 13 to the surround 52 and/or the fluid treatment element 11 to the shell 53. To allow fluid communication between the outer surface 42 of the fluid treatment medium 17 and a permeate outlet 34, the sealant may be applied in a manner that does not significantly inhibit permeate flow. For example, the sealant may be applied in a pattern of dots or dashes along the outer surface of the folded ends 23 of the pleats 20 between the opposite ends 15, 16 of the fluid treatment element 11. The shell 53 may be somewhat shorter than the fluid treatment element 11 allowing at least the initially-applied sealant 81 at each end of the fluid treatment element 11 to extend beyond the ends of the shell 53. Further, the length of the shell 53 may be greater than the axial extent of the surround 52, e.g., greater by about ½ inch or less to about 1½ inch or more, leaving a small annulus which extends radially from the outer diameter of the sealant 18 to the inner diameter of the shell 53 and axially from the end of the shell 53 to the axial end of the surround 52.

Additional sealant 18 may be applied between fluid treatment element 11 and the housing 12 to further seal the second surface 42 of the fluid treatment medium 17 from the ends of the fluid treatment element 11. The additional sealant 18 may also bond the fluid treatment element 11 to the housing 12. For example, the shell 53 and the fluid treatment element 11 may be positioned with the axis 14 vertical, and sealant 18 may be injected into the annulus at the lower end of the shell 53. The sealant 18 may fill the annulus and extend axially a short distance into the surround 52. Once the sealant 18 in the annulus solidifies, the shell 53 and the fluid treatment element 11 may be inverted and the sealant 18 may be injected into the annulus at the other end of the shell 53, completely sealing the second surface 42 of the fluid treatment medium 17 from the ends of the fluid treatment assembly 10 and firmly fixing the fluid treatment element 11 to the housing 12.

The stripout material 71 may be removed from the fluid treatment pack 13 at various times including, after the legs 25, 26 of adjacent pleats 20 are bonded to one another at the pack ends. For example, after the sealant 18 in the annulus solidifies, the end portion of the fluid treatment element 11 which extends beyond the housing 12 and contains the initially-applied sealant 81 may be cut, e.g., sliced, from the fluid treatment element 11. Cutting the initially-applied sealant 81 from the fluid treatment element 11 exposes the sealant barrier layer 70 and the stripout material 71 at the ends 15, 16 of the fluid treatment pack 13. The core 50 or core substitute may also be removed from the interior of the fluid treatment pack 13, further exposing the stripout material 71 along the interior of the fluid treatment pack 13. The stripout material 71 may then be pulled from the fluid treatment pack 13. The sealant barrier layer 70 prevented contact between the sealant 18 applied along the outer surface 42 of the fluid treatment medium 17 and the stripout material 71. Consequently, the stripout material 71 is not bonded to anything within the pack 13 and may simply be pulled from between the legs 25, 26 of the pleats 20 via one or both axial ends of the pack 13, leaving the regions 27 free of structure in place of the stripout material 71. Because the legs 25, 26 of the adjacent pleats 20 are bonded to one another in the end regions of the fluid treatment pack 13 and the fluid treatment medium 17 is bonded to the sealant 18 in the end regions of the fluid treatment pack 13, the regions 27 free of structure are maintained without obstruction along the inner surface of the fluid treatment medium 17. For most embodiments, the thin sealant barrier layer 70 may be fashioned from a material which does not bond to the sealant 18. Consequently, the sealant barrier layer 70 may be removed from the inner surface 41 of the fluid treatment medium 17 as or after the stripout material 71 is removed.

After the stripout material 71 has been removed and the regions 27 free of structure have been exposed, a core 50 may be installed in the interior of the fluid treatment pack 13. The core 50 may fit closely against the legs 25, 26 of the pleats 20 at the open ends 24, preventing axial flow from end to end of the fluid treatment pack that bypasses the regions 27 free of structure. For many embodiments, the core 50 may be bonded to the legs 25, 26 of the pleats 20 at the open ends 24 by a sealant. The sealant may be applied along the entire length of the core, e.g., as the core is inserted into the interior of the fluid treatment pack 13, or along only a portion of the core. For example, the sealant 64 may be applied between the core 50 and the pleats 20 only in the end regions of the fluid treatment pack 13, either as or after the core 50 is inserted in the interior of the fluid treatment pack 13. Once the sealant solidifies, the core 50 is firmly held in place within the pack 13.

Fluid treatment assemblies embodying the invention may be used to treat any of a myriad of fluids in any of numerous crossflow processes. For example, the fluid treatment assembly 10 shown in FIGS. 1-3 may be used in a separation process. The feed fluid inlet 32 and the retentate outlet 33 may be coupled to a feed line and a retentate outlet line (not shown), and a feed fluid may be introduced into the fluid treatment assembly at the open axial ends 21 of the pleats. The core 50 and the sealant 18 between the outer surface 42 of the fluid treatment medium 17 and the housing 12 direct the feed fluid from the feed line straight into the regions 27 free of structure, where it flows within the regions 27 free of structure axially along the tangential flow path 30 to the opposite open axial ends 22 of the pleats 20. Each region 27 free of structure is surrounded by the inner surface 41 of the fluid treatment medium 17 along the legs 25, 26 and the folded end 23 of the pleat 20. At the opposite open axial ends 22 of the pleats 20, the feed fluid exits the fluid treatment pack 13 and the fluid treatment assembly 10 via the retentate outlet 33, the retentate exiting the regions 27 free of structure straight into the retentate outlet line.

Within the regions 27 free of structure, one or more substances may be removed from the feed fluid via the lateral fluid flow path 31. The one or more substances may pass as permeate generally radially from the inner surface 41 to the outer surface 42 through the fluid treatment medium 17 and through the permeate drainage layer 43 to the surround 52. The permeate may then pass along the lateral flow path 31 generally axially along the surround 52 to the one of permeate outlets 34, which may be connected to permeate outline lines (not shown). The permeate then exits the fluid treatment assembly 10 via the permeate outlets 34 and the permeate outlet line. Either the permeate or the retentate or both may be the desired product of the separation process.

Many advantages are associated with fluid treatment elements and assemblies embodying the invention. For example, by providing regions free of structure, fluid treatment elements and assemblies embodying the invention offer less resistance to the flow of fluids, e.g., feed fluids. Where the fluids flow straight from the feel inlet line into the open axial ends of the regions free of structure and/or from the open axial ends of the regions free of structure straight into the retentate outlet line, there is even less resistance to fluid flow because there are fewer turning losses at the feed fluid inlet and the retentate outlet. Fluids may thus flow through the fluid treatment element or assembly with a smaller pressure drop. Further, by locating the regions free of structure immediately against the inner surface of the fluid treatment medium, fluid flowing along the tangential flow path can more thoroughly keep foulants clear of the surface of the fluid treatment medium, for example, because a much higher, more uniform shear rate can be provided at the surface of the medium. In addition, where regions free of structure extend along the fluid treatment medium free of obstructions, fewer foulants are deposited on the fluid treatment medium, and sensitive feed fluids, such as cellular solutions, may flow along the regions free of structure with little or no damage to the sensitive fluid or its components.

While various aspects of the invention have been previously described and/or illustrated, the invention is not limited to these embodiments. For instance, one or more of the features of any embodiment may be eliminated without departing from the scope of the invention. For example, the surround may be eliminated. Fluid may then flow between the permeate outlet and the fluid treatment medium via the permeate drainage layer. Alternatively or additionally, the inside surface of the housing may have passages which direct fluid between the permeate outlet and the fluid treatment medium. As another example, either or both of the permeate cushioning layer and the permeate support layer may be eliminated for fluid treatment media that are less susceptible to damage and better resist forces associated with fluid flow.

Further, one or more features of any embodiment may be modified without departing form the scope of the invention. For example, the permeate outlet may be positioned on the shell of the housing near one end and in fluid communication with the outer surface of the fluid treatment medium. The surround may then include a blind portion that may be impermeable and imperforate and may extend axially from the opposite end to near the permeate outlet. The blind portion of the surround may then serve to force permeate to flow axially within the permeate drainage layer along the lateral flow path to the permeate outlet.

As an example of another modification, the permeate cushioning layer and the permeate support layer may be merged into a single layer which serves the functions of both a cushioning layer and a support layer.

As an example of another modification, the housing may include end pieces and the end pieces may be joined to the ends of the shell. The end pieces may be generally circular and have a hollow, central fitting that protrudes outwardly and has a smaller outer diameter than the shell. The inside surface of each end piece may have lands, ribs or other structures that define passageways which communicate between the open axial ends of the regions free of structure and the interior of the central fitting of the end piece. The end pieces may be connected to the ends of the shell with the lands or ribs contacting the sealant at the ends of the fluid treatment element and the ends of the core. The fluid treatment element and the core may then be supported axially within the housing by the end pieces.

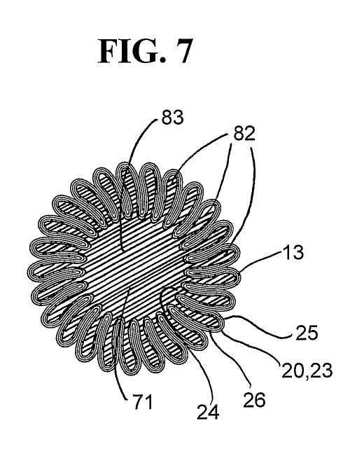

As an example of another modification, the stripout material may comprise a more rigid material and may be inserted in the pleats, e.g., in the axial ends of the pleats or the open ends of the pleats, after the corrugated fluid treatment pack is formed. For example, the stripout material may be configured as rigid fins which extend along a portion of, or the entire, axial length of the pleats. The fins may be separate, flat pieces having a width and height corresponding to the desired width and height of each region free of structure. Alternatively, the fins 82 may be attached to a core substitute 83, as shown in FIG. 7. The core substitute 83 may be slid into the interior of the fluid treatment pack 13 with the fins 82 sliding through the open axial ends 24 and between the legs 25, 26 of the pleats 20. The fluid treatment pack and the more rigid stripout material may be dipped into the cup-shaped fixture containing the initially-applied sealant. The surround and the other sealants may be applied and the fluid treatment element may be disposed in the housing, as previously described. After the initially-applied sealant is cut from each end of the fluid treatment element, the more rigid stripout material may be pulled from the fluid treatment pack, leaving the regions free of structure in place of the stripout material, e.g., in place of the fins.

As another example of a modification, the stripout material may be removed from the fluid treatment pack after the sealant is applied to the surface, e.g., the outer surface, of the fluid treatment medium but before the fluid treatment element is inserted in the shell or before the surround is placed around the pack. After the sealant has been applied to the outer surface of the fluid treatment medium and has solidified, the end portion of the fluid treatment packing having the originally-applied sealant may be cut from the fluid treatment pack, exposing the stripout material at the ends of the pack. The core or the core substitute may be removed, and the stripout material may be removed, leaving the regions free of structure within the fluid treatment pack along the inner surface of the fluid treatment medium. The surround may then be placed around the fluid treatment pack, the fluid treatment element may be placed inside the shell, the remaining sealant may be applied in the annulus, and the core may be installed in the interior of the fluid treatment pack.

Further, one or more features of any embodiment may be combined with one or more features of other embodiments. For example, the end pieces may be combined with an embodiment having fluid passages on the inner surface of the shell of the housing.

Further, embodiments having very different features can still be within the scope of the invention. For example, the fluid treatment assembly may comprise a disposable fluid treatment element which is removably mounted in and sealed to a reusable housing, such as a reusable shell. After the disposable fluid treatment element is spent, it may be removed from the reusable housing and replaced by a new or cleaned fluid treatment element.

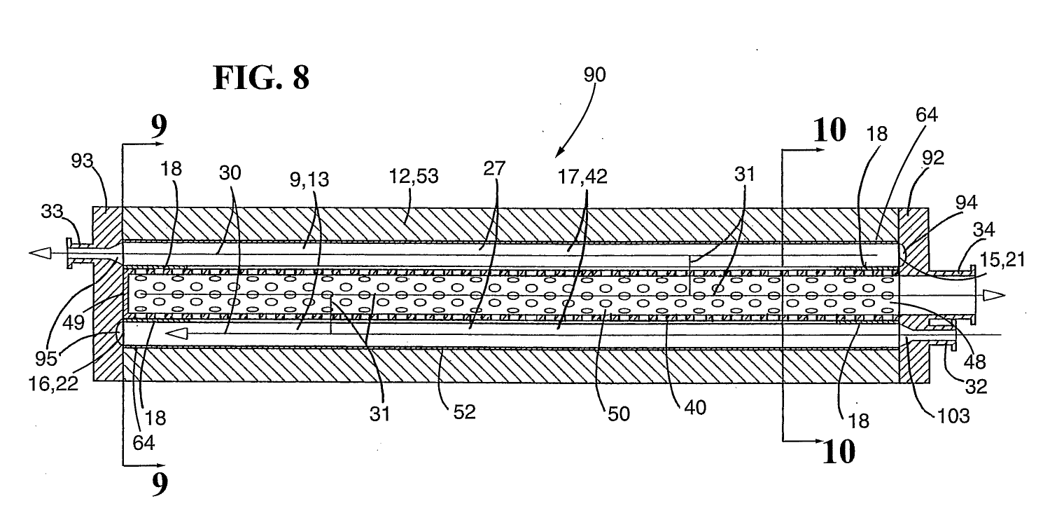

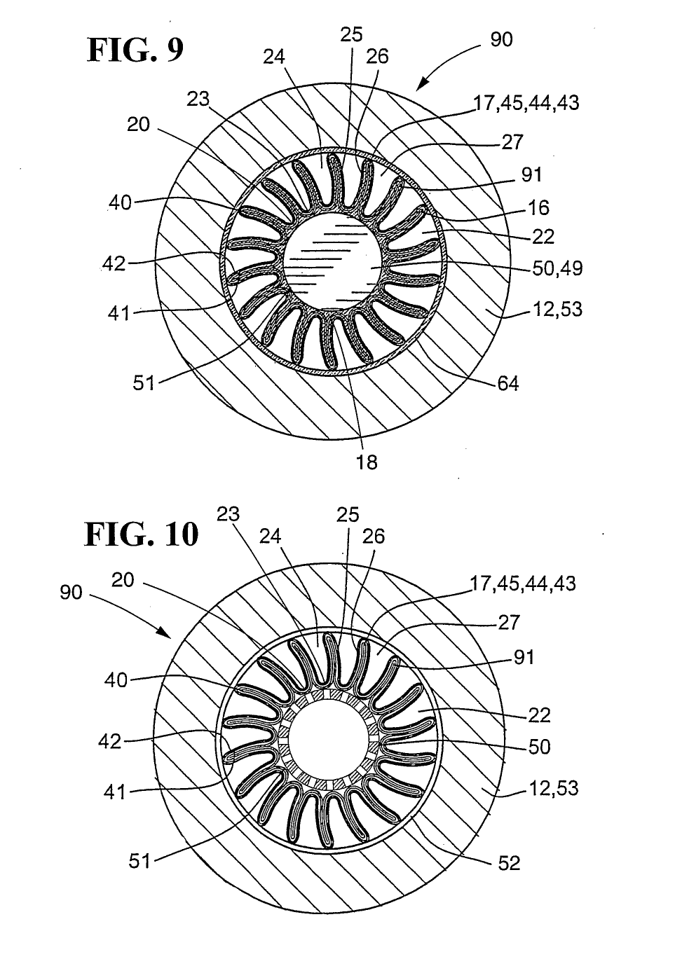

As another example, fluid treatment elements and assemblies may have regions free of structure which extend within the pleats along the outer surface of the fluid treatment medium rather than the inner surface. One example of such a fluid treatment assembly 90 and fluid treatment element 91 is shown in FIGS. 8-10. The features of the fluid treatment assembly 90 shown in FIGS. 8-10, including the components and the methods of making and using the assembly 90, are similar to those of the fluid treatment assembly 10 shown in FIGS. 1-3, and corresponding components are identified by the same reference numerals. However, the geometry of the fluid treatment assembly 90 may generally be reversed with respect to the fluid treatment assembly 90 shown in FIGS. 1-3. For example, the permeate cushioning layer 45, the permeate support layer 44, and the permeate drainage layer 43 may be positioned along the inner surface 41 of the fluid treatment medium 17, while the regions 27 free of structure may extend axially along the outer surface 42 of the fluid treatment medium 17.

The fluid treatment assembly 90 may include a fluid treatment element 11 disposed in a housing 12. The fluid treatment element 11 may include a fluid treatment pack 13 having a central axis, opposite ends 15, 16, a fluid treatment medium 17, and a plurality of axially extending pleats 20. Each pleat 20 has a folded inner end 23, an open outer end 24, two legs 25, 26 which extend between the folded end and the open end, and opposite open axial ends 21, 22 at the opposite ends 15, 16 of the fluid treatment pack 13. All or substantially all of the pleats 20 include a region 27 free of structure which extends axially within each pleat 20 along the full length of the pleat 20 between the axial ends 21, 22 and opens onto the axial ends 21, 22 of the pleat 20. Each region 27 free of structure extends axially within the pleat 20 along the outer surface of the fluid treatment medium 17. A sealant 18 at each end of the fluid treatment pack 13 seals the inner surface 41, e.g., the permeate side, of the fluid treatment medium 17 from the ends 15, 16 of the fluid treatment pack 13. The fluid treatment element 11 further includes a tangential fluid flow path 30 and a lateral fluid flow path 31. The tangential fluid flow path 30 extends generally axially along the fluid treatment pack 13 within the pleats 20, including the regions 27 free of structure. The lateral fluid flow path 31 fluidly communicates with the tangential fluid flow path 30 and extends laterally through the fluid treatment medium 17 to or from the tangential fluid flow path 30.

Fluid treatment elements and assemblies having regions free of structure which extend along the outer surface of the fluid treatment medium may be coreless. However, many embodiments may include a core 50. The core 50 may be hollow and perforated or permeable, and the interior of the core 50 may fluidly communicate along all or most of the axial length of the core 50 with the inner surface 41 of the fluid treatment medium 17 via the permeate cushioning layer 45, the permeate support layer 44, and the permeate drainage layer 43. The core 50 may have an open end 48 and an opposite blind end 49 or two open ends. The surround 52 may be blind, e.g., impermeable and imperforate, along its entire length, or it may be omitted.

The housing 12 may include an outer shell 53, and opposite end pieces 92, 93 attached to the shell 53. The shell 53 may be closely fitted around the exterior of the fluid treatment element 11. A sealant 64 may be positioned between the shell 53 and the pleats 20 at each end of the fluid treatment pack 13. Additionally, a sealant may be positioned between the surround 52 and the pleats 20 along the length of the fluid treatment pack 13. One end piece 92 may include a feed fluid inlet 32 and a manifold 94 which fluidly communicates between the feed fluid inlet 32 and the regions 27 free of structure at the open axial ends 21 of the pleats 20 at one end of the fluid treatment pack 13. The opposite end piece 93 may include a retentate outlet 33 and a manifold 95 which fluidly communicates between the retentate outlet 33 and the regions 27 free of structure at the open axial ends 22 of the pleats 20 at the opposite end of the fluid treatment pack 13. Either or both end pieces may include a permeate outlet. In the illustrated embodiment, the end piece 92 on the feed end may include a permeate outlet 34, which may be sealed to the open end 48 of the core 50, such that the retentate and the permeate are separated from one another. The other end of the core 50 may be a blind end 49. The end pieces 92, 93 may be attached to the shell 53 to support the fluid treatment element 11 and the core 50 within the housing 12.

Although the fluid treatment assembly 90 shown in FIGS. 8-10 may include end pieces 92, 93, fluid treatment assemblies having regions free of structure which extend along the outer surface of the fluid treatment medium may be free of end pieces. For example, fluid treatment assemblies having regions free of structure along the outer surface of the fluid treatment medium may include a housing similar to the housing 12 of the fluid treatment assembly 10 shown in FIG. 1, including a shell having fittings at each end. A feed pipe and a retentate pipe having inner diameters comparable to the inner diameter of the shell may be attached to the fittings at the feed inlet end and the retentate outlet end of the shell, respectively. A permeate outlet pipe may be attached to the core at one or both ends of the fluid treatment element and extend a distance within the feed pipe and/or the retentate pipe. Either the permeate outlet pipe or the feed pipe and/or the retentate pipe may bend, allowing the permeate outlet pipe to extend through the wall of the feed pipe and/or retentate pipe, separating the permeate fluid from the feed fluid and/or the retentate fluid.

Methods of making a fluid treatment assembly having regions free of structure along the outer surface of the fluid treatment medium may be similar to those for making a fluid treatment assembly having regions free of structure along the inner surface of the fluid treatment medium, as previously described. However, the sealant barrier layer and the stripout layer may be positioned in the multilayer composite 40 along the surface of the fluid treatment medium 17 which will become the outer surface 42 or feed side. The permeate drainage layer 43, the permeate support layer 44, and the permeate cushioning layer 45 may be positioned in the composite 40 along the surface of the fluid treatment medium 17 which will become the inner surface 41 or permeate side.

Additionally, the initially-applied sealant 81 and the sealant 18 which seals the inner surface 41 of the fluid treatment medium 17 from the ends of the fluid treatment pack 13 may be applied in a cup-shaped fixture 100, as shown in FIG. 11, which is similar to the cup-shaped fixture 80 shown in FIG. 6. However, the fixture 100 shown in FIG. 11 further includes a central cylindrical protrusion 101 that has an outer diameter which corresponds to the inner diameter of the fluid treatment pack 13. The central protrusion 101 extends upwardly about 1 inch or less to about 1¼ inch or more and may have a slight inward taper near the top. For each end, the fluid treatment pack 13 is dipped into an initially-applied sealant 81 in the bottom of the fixture 100, filling the entire end of the fluid treatment pack 13 to a depth of up to about ⅛ inch or more. The sealant 81 then solidifies. The sealant 18 for the inner surface 41 of the fluid treatment medium 17 may then be applied between the fluid treatment pack 13 and the central cylindrical protrusion 101 of the fixture 100, for example, by means of a long needle inserted into the hollow interior of the fluid treatment pack 13 from the opposite end of the pack 13. The sealant 18 fills all of the void spaces in the fluid treatment pack 13 at each end 15, 16 radially between the inner surface 41 of the fluid treatment medium 17 and the outer diameter of the central cylindrical protrusion 101 and axially from the initially-applied sealant near the bottom of the fixture 100 to the bottom of the taper near the top of the cylindrical protrusion 101.

After the sealant 18 solidifies, the inner surface 41 of the fluid treatment medium 17 may be sealed from the ends 15, 16 of the fluid treatment pack 13. The permeate drainage layer 43 and the fluid treatment medium 17, as well as the permeate support layer 44 and the permeate cushioning layer 45, may be effectively bonded to one another inwardly from the fluid treatment medium 17 in the end region of the fluid treatment pack 13. Further, the legs 25, 26 of adjacent pleats 20 may be effectively bonded to one another inwardly from the fluid treatment medium 17 in the end region of the fluid treatment pack 13. However, the stripout material 71 and the sealant barrier layer 70 may be bonded to the fluid treatment pack 13 only by the initially-applied sealant 81.

After the sealant 18 solidifies and the legs 25, 26 of adjacent pleats 20 are bonded to one another in the end regions of the fluid treatment pack 13, the stripout material 71 may be removed from the pack 13. For example, the portion of the fluid treatment pack 13 containing the initially-applied sealant 81 may be cut from the pack 13, allowing the stripout material 71 and the sealant barrier layer 70 to be removed from the pack 13. The stripout material 71 may then be pulled from the exterior of the fluid treatment pack 13, leaving the regions 27 free of structure to extend axially along each pleat 20 and open at both axial ends 21, 22 of the pleats. The sealant barrier layer 70 may also be removed from exterior of the fluid treatment pack 13.

After the stripout material 71 is removed from the fluid treatment pack 13, a surround 52 may, or may not, be applied to the exterior of the fluid treatment pack 13 at the open outer ends 24 of the pleats 20. The fluid treatment element 11 may be inserted into the shell 53 of the housing 12 and may, or may not, be bonded to the shell 53 by a sealant positioned between the inner surface of the shell 53 and surround 52 or the legs 25, 26 of adjacent pleats 20 at the open outer ends 24 of the pleats 20.

The perforated core 50 may be installed at various times, e.g., after the sealant 18 is applied along the inner surface 41 of the fluid treatment medium 17 and the initially-applied sealant 81 is cut from the fluid treatment pack 13. Additional sealant 18 may be applied between the core 50 and the folded inner ends 23 of the pleats 20 in the end regions of the pack 13 to more completely seal the inner surface 41 of the fluid treatment medium 17 from the manifold 94, 95 of each end piece 92, 93 and to fix the core 52 to the fluid treatment pack 13. After the core 50 is installed in the fluid treatment pack 13 and the fluid treatment element 10 is installed in the shell 53, the end pieces 92, 93 may be attached to the ends of the shell 53 and sealed to the core 50 to form the fluid treatment assembly 90.

In use, feed fluid may be directed along the tangential flow path 30 into the feed inlet 32 and the inlet manifold 94. From the inlet manifold 94, the feed fluid flows generally axially into the open axial ends 21 of the pleats 20 at one end 15 of the fluid treatment pack 13, through the regions 27 free of structure along the outer surface 42 of the fluid treatment medium 17, to the open axial ends 22 of the pleats 20 at the opposite end 16 of the pack 13, and into the outlet manifold 104. From the outlet manifold 95, the retentate exits the fluid treatment assembly 90 via the retentate outlet 33. For many embodiments, one or more components of the feed fluid are removed in the regions 27 free of structure via the lateral flow path 31. The components flow generally radially from the outer surface 42 to the inner surface 41 through the fluid treatment medium 17 and through the permeate cushioning layer 45, the permeate support layer 44 and the permeate drainage layer 44 to the interior of the perforated core 50. The permeate then flows along the lateral flow path generally axially along the interior of the core 50 and the through the permeate outlet 34.

As another example of an embodiment having very different features, a fluid treatment assembly may be configured as a mass transfer device. For example, a fluid treatment assembly similar to the fluid treatment assembly 10 shown in FIGS. 1-3. An impermeable, imperforate surround may be positioned around the exterior of the fluid treatment pack most of the axial distance between the two ports in the shell. A first fluid, e.g., a gas or a liquid, may enter the fluid treatment assembly through one of the ports, pass axially along the outer surface of the fluid treatment medium through the outer drainage layer, the outer support layer, and the outer cushioning layer, and exit through the other port. Another fluid may flow co-current or counter current along tangential flow path from the fluid inlet axially along the regions free of structure to the fluid outlet. One or more components of one of the fluids, e.g., the first fluid flowing along the outer surface of the fluid treatment medium, may pass through the fluid treatment medium along the lateral flow path to the fluid flowing into the regions free of structure.

The present invention is thus not restricted to the particular embodiments which have been described and/or illustrated but includes all modifications, combinations, and different embodiments that fall within the scope of the claims.

1. A fluid treatment element comprising:
a fluid treatment pack which includes a fluid treatment medium, an axis, first and second opposite ends, and a plurality of pleats extending axially between the first and second ends, wherein the fluid treatment medium has first and second surfaces and wherein each pleat includes first and second axial ends at the first and second ends of the fluid treatment pack, each pleat further including a folded end, an open end, first and second legs extending between the folded end and the open end, and a region free of structure, the region free of structure extending axially within the pleat between the first and second axial ends along the first surface of the fluid treatment medium and opening onto the first and second axial ends of the pleat;
a sealant sealing each end of the fluid treatment pack from the second surface of the fluid treatment medium;
a first fluid flow path which extends axially along the fluid treatment pack within the pleats, the first fluid flow path including the regions free of structure; and
a second fluid flow path which extends through the fluid treatment medium from or to the first fluid flow path.

2. The fluid treatment element of claim 1 wherein the first surface of the fluid treatment medium comprises an outer surface.

3. The fluid treatment element of claim 1 wherein the first surface of the fluid treatment medium comprises an inner surface.

4. The fluid treatment element of claim 1 wherein the region free of structure extends across the pleat from the first leg to the second leg.

5. The fluid treatment element of claim 1 wherein the region free of structure extends along the height of the pleat from the folded end to the open end.

6. The fluid treatment element of claim 1 wherein the region free of structure adjoins the first surface of the fluid treatment medium.

7. The fluid treatment element of claim 1 wherein the fluid treatment pack has a generally cylindrical configuration and an exterior, the fluid treatment element further comprising a surround positioned around the exterior of the fluid treatment pack.

8. The fluid treatment element of claim 1 wherein the fluid treatment pack has a hollow, cylindrical configuration having an interior, the fluid treatment element further comprising a core positioned in the interior of the fluid treatment pack.

9. The fluid treatment element of claim 8 wherein the core is bonded to the fluid treatment pack at the first and second ends of the fluid treatment pack.

10. A fluid treatment assembly comprising a fluid treatment element as claimed in claim 1 and a housing positioned around the fluid treatment element.

11. The fluid treatment assembly of claim 10 wherein the housing comprises a shell, the fluid treatment element being bonded to the shell, and wherein the housing is free of end pieces.

12. A fluid treatment element comprising:
a hollow, generally cylindrical fluid treatment pack which includes an axis, an interior, first and second opposite ends, and a pleated composite, wherein the pleated composite includes a fluid treatment medium having an inner surface and an outer surface and defines a plurality of pleats extending axially between the first and second ends of the fluid treatment pack and wherein each pleat includes first and second axial ends at the first and second ends of the fluid treatment pack, each pleat further including a folded outer end, an open inner end, first and second legs extending between the folded outer end and the open inner end, and a region free of structure, the region free of structure extending axially within the pleat between the first and second axial ends along the inner surface of the fluid treatment medium and opening onto first and second axial ends of the pleat;
a sealant sealing each end of the fluid treatment pack from the outer surface of the fluid treatment medium; and
a core positioned in the hollow interior of the fluid treatment pack along the open inner ends of the pleats.

13. The fluid treatment element of claim 12 wherein the region free of structure adjoins the inner surface of the fluid treatment medium.

14. The fluid treatment element of claim 12 wherein the core is bonded to the fluid treatment pack.

15. The fluid treatment element of claim 12 further comprising a surround positioned around the exterior of the fluid treatment pack.

16. A fluid treatment assembly comprising a fluid treatment element of claim 12 and a housing positioned around the fluid treatment element.

17. A fluid treatment element of claim 15 further wherein the housing comprises a shell, the fluid treatment element being bonded to the shell, and wherein the housing is free of end pieces.

18. A fluid treatment element comprising:
a generally cylindrical fluid treatment pack which includes an axis, an exterior, first and second opposite ends, and a pleated composite, wherein the pleated composite includes a fluid treatment medium having an inner surface and an outer surface and a defines a plurality of pleats extending axially between the first and second ends and wherein each pleat includes first and second axial ends at the first and second ends of the fluid treatment pack, each pleat further including a folded inner end, an open outer end, first and second legs extending between the folded inner end and the open outer end, and a region free of structure, the region free of structure extending axially within the pleat between the first and second axial ends along the outer surface of the fluid treatment medium and opening onto first and second axial ends of the pleat;
a sealant sealing each end of the fluid treatment pack from the inner surface of the fluid treatment medium; and
an outer surround positioned around the exterior of the fluid treatment pack along the open outer ends of the pleats.

19. The fluid treatment element of claim 18 wherein the region free of structure adjoins the outer surface of the fluid treatment medium.

20. The fluid treatment element of claim 18 further comprising a core positioned in a hollow interior of the fluid treatment pack.

21. A fluid treatment assembly comprising the fluid treatment element of claim 18 and a housing positioned around the fluid treatment element.

22. The fluid treatment assembly of claim 21 wherein the housing includes a shell and end pieces attached to each end of the shell.

23. A method of making a fluid treatment element comprising:
forming a composite including a fluid treatment medium having first and second opposite surfaces and a stripout material positioned along the first surface of the fluid treatment medium;
corrugating the composite to form a plurality of pleats;
forming the corrugated composite into a generally cylindrical fluid treatment pack having first and second ends, wherein the pleats extend axially along the fluid treatment pack;
applying a sealant to the fluid treatment pack near the first and second ends to seal the ends of the fluid treatment pack from the second surface of the fluid treatment medium; and
after applying the sealant, removing the stripout material from the corrugated composite to form a region within each pleat that is free of structure.

24. The method of claim 23 wherein forming the composite includes positioning a sealant barrier layer between the fluid treatment medium and the stripout material.

25. The method of claim 23 further comprising applying an initial sealant to both ends of the fluid treatment pack to seal each end entirely before the sealant is applied to the fluid treatment pack to seal the ends of the pack from the second surface of the fluid treatment medium.

26. The method of claim 25 further comprising cutting the initial sealant from both ends of the pack to expose the stripout material before the stripout material is stripped from the corrugated composite.

27. A method of making a fluid treatment element comprising:
corrugating a fluid treatment medium having first and second opposite surfaces to form a plurality of pleats;
forming the corrugated fluid treatment medium into a generally cylindrical fluid treatment pack having first and second ends, wherein the pleats extend axially along the fluid treatment pack, between the first and second ends;
positioning a stripout material along the first surface of the fluid treatment medium;
applying a sealant to the fluid treatment pack near the first and second ends to seal the ends of the fluid treatment pack from the second surface of the fluid treatment medium; and
after applying the sealant, removing the stripout material from the corrugated fluid treatment pack to form a region within each pleat that is free of structure.

28. The method of claim 27 further comprising forming a composite including the fluid treatment medium and the stripout material, wherein positioning the stripout material includes locating the stripout material along the first surface of the fluid treatment medium in the composite.

29. The method of claim 27 wherein positioning the stripout material includes inserting the stripout material into the pleats of the generally cylindrical fluid treatment pack along the first surface of the fluid treatment medium.
